(19) United States
(12) Patent Application Publication
(10) Pub. No.: US 2016/0303759 A1
(43) Pub. Date: Oct. 20, 2016

(54) Method for Producing a Partially Solidified Wood Fiber Board, Partially Solidified Wood Fiber Board, and Device for Producing Same

(71) Applicant: Cefla Deutschland GmbH, Meckenheim (DE)

(72) Inventor: Gerhard Stahl, Bad Neuenahr-Ahrweiler (DE)

(21) Appl. No.: 15/097,829

(22) Filed: Apr. 13, 2016

(30) Foreign Application Priority Data
Apr. 15, 2015 (DE) 10 2015 206 804.8

(51) Int. Cl. B27K 3/08; B44C 5/04; B27K 3/10; B05B 9/00

(52) U.S. Cl. CPC B27K 3/08; B05B 9/00; B44C 5/043; B27K 3/10

(57) ABSTRACT

A method for producing a partially solidified wood fiber board which prior to partial solidification has already been cut to size, includes the defining of a solidification area. Within the solidification area, solidifying agent is applied onto a top side of the wood fiber board. Particularly with the aid of a pressure bell and/or a suction bell, a pressure difference can be generated between the top side and the bottom side of the wood fiber board for suction of the solidifying agent into the wood fiber board.

### CROSS-REFERENCE TO RELATED APPLICATION

This application claims priority to German Patent Application No. 10 2015 206 804.8 filed Apr. 15, 2015, the disclosure of which is hereby incorporated in its entirety by reference.

### BACKGROUND OF THE INVENTION

1. Field of the Invention

The present invention relates to a method for producing a partially solidified wood fiber board such as e.g. a chip board, an MDF board and the like. Further, the invention relates to a partially solidified wood fiber board and a device for producing a partially solidified wood fiber board.

2. Description of the Prior Art

For solidification of wood fiber boards, these can be provided with a solidifying agent so that the danger of swelling particularly due to humidity will be reduced. Such a treatment is performed e.g. on boards for laminate flooring. In this method, described e.g. in EP 11 000 068, the solidifying agent is applied in a strip-like configuration onto the wood fiber board that still will have to be cut to size. Subsequently, the entire top side of the wood fiber board is subjected to pressurized air and, on the opposite side, an underpressure is applied, so as to press and respectively suck the solidifying agent into the board. The board will then be cut to size along the solidifying strips.

Further, in the production of e.g. doors, side walls of cabinets and the like, a problem exists in that the fastening of hinges and the like in wood fiber boards is prone to difficulties. For instance, the screws may happen to break out from the corresponding sites. To solve this problem, it is known that, already during the production of the wood fiber boards while the large-sized wood fiber boards have not yet been cut to size, the strength of the board can be enhanced, notably by increasing the number of wood chips, in those areas where a hinge or the like may be installed later on. During the subsequent pressing of the wood fiber board, areas of higher strength will be generated there. This method, however, has to be performed already during the production of the wood fiber board, i.e. before the wood fiber board will be precisely cut to size. For this reason, it is required to generate relatively larger areas of increased strength because the later exact position of the hinges or the like is not known. Further, the non-uniform distribution of the wood chips is prone to problems.

It is an object of the invention to provide a method for producing a partially solidified wood fiber board, which method shall be suited particularly for producing doors, side walls of cabinets and the like and particularly shall allow for reliable fastening of hinges and the like. It is a further object of the invention to provide a corresponding wood fiber board and also a device for producing the same.

### SUMMARY OF THE INVENTION

A feature of the method of the invention resides in that, prior to being partially solidified, the wood fiber board has already been cut to size. In this state, the wood fiber board has been cut to its final size at least roughly and preferably already completely. The cut-to-size wood fiber board will be arranged in a solidification device, or said solidification device will be arranged on the wood fiber board. Further, there will be determined at least one solidification area which is particularly an area where a hinge or another component shall be connected to the wood fiber board with the aid of screws of the like. The determining of the at least one solidification area can be performed prior or subsequent to arranging the wood fiber board relative to the solidification device, or also during said arranging process. Then, there is performed a partial application of solidifying agent on a top side of the wood fiber board within said at least one solidification area. As a solidifying agent, use can be made particularly of PUR with an isocyanate. Thereafter, a pressure difference will be generated in the solidification area between the top side and a bottom side, particularly opposite to the top side, of the wood fiber board. Thereby, the solidifying agent will be sucked and respectively pressed into the wood fiber board. Thus, using the method of the invention, an exactly defined solidification area on which e.g. a hinge can be arranged, can be provided in a simple manner at a later time, i.e. on a wood fiber board that has already been cut to size, thus guaranteeing a solidification of an exactly defined area

Particularly the two steps of arranging the cut-to-size wood fiber board in a solidification device and respectively arranging the solidification device on the wood fiber board, and of determining the at least one solidification area are independent from each other with respect to their order. It is particularly preferred that these two steps are performed simultaneously, as explained hereunder in the context of a preferred embodiment of the device.

Application of the solidifying agent is preferably performed by spray deposition.

With particular preference, for generating the pressure difference, a pressure bell is provided that will be applied onto the top side of the wood fiber board in the solidification area. By the generating of overpressure in the pressure bell, the pressure difference between the top side and the bottom side will be established and the solidifying agent will penetrate into the wood fiber board due the pressure difference. It is particularly possible herein that the solidification area will be defined by the pressure bell. Further, it is particularly preferred that an application device for applying the solidifying agent, particularly a spraying nozzle, is arranged in the pressure bell. It is thus possible to place the pressure bell onto the solidification area, to then apply solidifying agent particularly by spraying and then, again immediately thereafter, to introduce the agent into the wood fiber board by pressure generation. Thus, in this preferred embodiment of the method of the invention, no additional handling or the like of the board will be required. Instead, the solidifying of the corresponding area will be performed in one workstep. It is further preferred herein that the pressure bell itself, optionally together with other holding elements, is used for realizing the arranging of the cut-to-size wood fiber board in the solidification device and, respectively, that the pressure bell in the function of a solidification device will be arranged on the wood board.

According to a particularly preferred embodiment of the invention, a suction bell is provided. The suction bell can be provided additionally or alternatively to the pressure bell. Particularly, the suction bell is adapted to be placed onto the bottom side of the wood fiber board in an area opposite to the solidification area. By generating an underpressure in the suction bell, solidifying agent that is applied—particularly by spray deposition—onto the top side of the wood fiber board in the solidification area, can be sucked into the board in a simple manner. Even if only a suction bell and no pressure bell is provided, these worksteps can be synchronized with each other in a favorable way so that the production process can be carried out in a very fast and simple manner.

It is particularly preferred to provide both a pressure bell and a suction bell which are arranged opposite to each other. Particularly, these can be arranged on the wood fiber board corresponding to a gripping arrangement so that the mutually opposite bells will grip the wood fiber board in the solidification area and respectively will be pressed onto the top side and/or the bottom side of the wood fiber board. Subsequently, the solidifying agent can be applied particularly by a nozzle in the pressure bell and be directly caused to penetrate into the wood fiber board by application of overpressure in the pressure bell and underpressure in the suction bell. In this manner, the generating of solidification areas where particularly hinges or the like shall be arranged, can be realized in a precise, fast and simple manner.

Preferably, the outer contour of the solidification area is cornerless. Thus, the solidifying agent can be sucked in and respectively pressed in uniformly. Particularly, the outer contour comprises only curved or straight sections. With particular preference, the solidification area has the shape of a circle, partial circle, oval or partial oval.

The invention further relates to a wood fiber board comprising at least one solidification area having a cornerless outer contour. The solidification area particularly comprises an outer contour having only straight or curved lines. Preferably the solidification area has the shape of a circle, partial circle, oval or partial oval. Preferably, the wood fiber board is a wood fiber board that has already been cut to size. With particular preference, the wood fiber board has been processed in the manner described above by way of the method of the invention. Preferably, the wood fiber board has been produced by the above described method according to the preferred modifications of the method.

The invention further relates to a device for producing a partially solidified wood fiber board, wherein said device particularly is suited for performing the above described method. The device of the invention comprises an application device such as e.g. a spray nozzle for application of a solidifying agent in a solidification area on a top side of the wood fiber board. The wood fiber board is a wood fiber board that has already been cut to size, or a large-sized board. In the solidification area, a pressure bell can be arranged on the top side of the wood fiber board. Additionally or alternatively to the provision of a pressure bell, a suction bell can be provided on a bottom side of the wood fiber board in an area opposite to the solidification area. By application of overpressure in the pressure bell and/or by application of underpressure in the suction bell, a pressure difference can be generated between the top side and the bottom side of the wood fiber board so that the solidifying agent will be introduced and respectively sucked into the wood fiber board.

Preferably, said application device, particularly designed as a nozzle, is arranged in the pressure bell. Thereby, particularly in a wood fiber board already cut to size, a solidification area can be generated in a fast and simple manner in an exactly defined area as described above by way of said method.

The device of the invention is preferably modified in an advantageous manner particularly as described above in the context of the method of the invention.

### BRIEF DESCRIPTION OF THE DRAWINGS

A full and enabling disclosure of the present invention, including the best mode thereof, enabling one of ordinary skill in the art to carry out the invention, is set forth in greater detail in the following description, including reference to the accompanying drawing in which

FIG. 1 is a schematic lateral view of a device for producing a partially solidified wood fiber board in simplified representation, and

FIG. 2 is a schematic plan view of a wood fiber board comprising a solidification area produced by the device illustrated in FIG. 1.

### DETAILED DESCRIPTION OF PREFERRED EMBODIMENTS

A wood fiber board 10 such as e.g. a cabinet door, a lateral wall of a cabinet or the like that has already been cut to size, will be arranged in a solidification device 12 or will be gripped by a solidification device 12. In the illustrated exemplary embodiment, the solidification device 12 comprises a pressure bell 14 and a suction bell 16 arranged opposite to pressure bell 14 on the other side of the wood fiber board 10. The two bells 14, 16, while arranged opposite to each other, will be pressed onto a top side 18 and respectively a bottom side 20 of the wood fiber board 10. In this state, there is generated particularly a tight closure between the edge of the bells contacting the wood fiber board 10 and the wood fiber board 10. Particularly, the two bells are identical in their size and have a spherical shape to the effect that a preferably annular edge is realized between the bells 14, 16 and the corresponding side 18 and respectively 20 of the wood fiber board 10. It is preferred that the two bells are shaped substantially as hemispheres.

According to a particularly preferred, simple embodiment of the invention, a solidification area 14 is realized in such a manner that the area of top side 18 that is arranged under the bell will form the solidification area 22.

In the illustrated preferred embodiment, an application device 24 is arranged in the pressure bell, particularly in the central upper area of the latter. Said application device serves for applying, particularly spraying, solidifying agent onto solidification area 22. For this purpose, nozzle 24 is connected via a hose 26 to a corresponding device which contains a supply of said agent and which optionally is operative for injection.

Further, pressure bell 14 is connected to a pressure hose 28 which is connected to a pressure device (not shown) so that pressurized air can be supplied in the direction represented by arrow 30.

Suction bell 16 arranged opposite to pressure bell 14 comprises a suction hose 32 provided with a suction device, so that air can be sucked off from the interior of suction bell 16 in the direction represented by arrow 34. As a result, an overpressure p⁺ is generated in pressure bell 14 and an underpressure p⁻ is generated in bell 16.

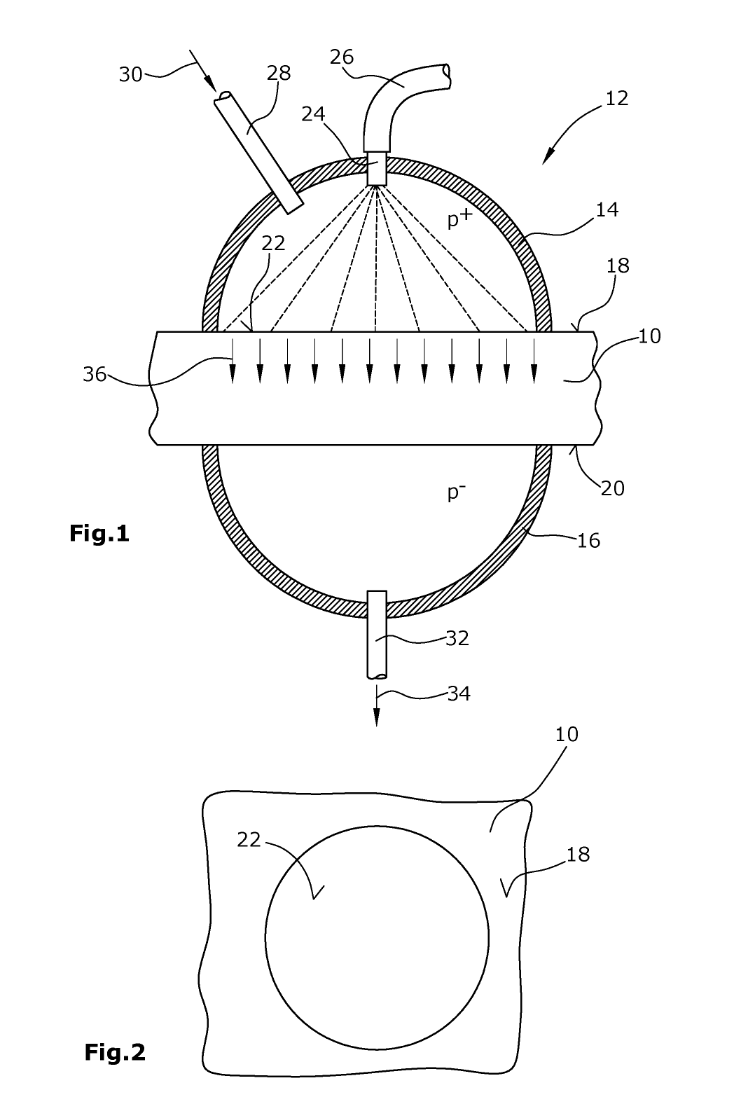

For performing the method of the invention by use of the preferred device shown in FIG. 1, the two bells, while arranged opposite to each other, can be pressed simultaneously onto the corresponding sides 18, 20 of the wood fiber board 10. This has the immediate effect that the solidification device 12 is defined and the wood fiber board 10 is held in place. Subsequently, solidifying agent will be applied, particularly by spray application, with the aid of nozzle 24. Immediately thereafter, pressurized air will be fed to pressure bell 14 via pressure hose 28 while, at the same time, air will be sucked from suction bell 16 via suction hose 32, thus generating a pressure difference. This will cause the solidifying agent applied onto the top side of solidification area 22 to be penetrate into the wood fiber board, as represented by arrows 36.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A method for producing a partially solidified wood fiber board, said method comprising:
arranging a cut-to-size wood fiber board on a solidification device,
defining at least one solidification area,
partially applying solidifying agent on a top side of the wood fiber board in said at least one solidification area, and
generating a pressure difference between said top side and a bottom side of the wood fiber board for causing the solidifying agent to be sucked into the wood fiber board.

2. The method of claim 1, wherein the application of the solidifying agent is performed by spray deposition.

3. The method of claim 1, wherein a pressure bell is applied onto the top side of the wood fiber board in the solidification area and an overpressure is generated in the pressure bell for generating the pressure difference between the top side and the bottom side of the wood fiber board.

4. The method according to claim 1, wherein a suction bell is placed onto the bottom side of the wood fiber board in an area opposite to the solidification area and an underpressure is generated in the suction bell for establishing the pressure difference.

5. The method according to claim 3, wherein the solidifying agent is applied after the pressure bell has been placed on the top side of the wood fiber board.

6. The method according to claim 1, wherein the solidification area has a cornerless and/or curved outer contour.

7. The method according to claim 1, wherein the solidification area has the shape of a circle, partial circle, oval or partial oval.

8. The method according to claim 1, wherein the solidification area has a curved and/or cornerless outer contour.

9. A wood fiber board comprising a solidification area having a cornerless outer contour, wherein the wood fiber board has been produced according to the method defined in claim 1.

10. A device for producing a partially solidified wood fiber board, said device comprising:
an application device for application of solidifying agent in a solidification area on a top side of the wood fiber board,
a pressure bell on the top side of the wood fiber board, said pressure bell being adapted to be placed in and respectively around the solidification area, and/or
a suction bell adapted to be placed on a bottom side of the wood fiber board in an area opposite to the solidification area,
wherein, by application of overpressure in the pressure bell and/or by application of underpressure in the suction bell, a pressure difference can be generated between the top side and the bottom side of the wood fiber board for introduction of the solidifying agent into the wood fiber board.

11. The device according to claim 10, wherein the application device is arranged in the pressure bell and is connected to the pressure bell and/or the application device comprises an application nozzle.
